(19) United States
(12) Patent Application Publication
(10) Pub. No.: US 2010/0060435 A1
(43) Pub. Date: Mar. 11, 2010

(54) APPARATUS FOR SUPPORTING A MEDICINE-TAKING SERVICE AND METHOD FOR SUPPORTING A MEDICINE-TAKING SERVICE USING THE SAME

(76) Inventors: Sun Lee BANG, Daejeon (KR); Jae Hun CHOI, Daejeon (KR); Myung Eun LIM, Daejeon (KR); Dae Hee KIM, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/369,083

(22) Filed: Feb. 11, 2009

(30) Foreign Application Priority Data
Sep. 10, 2008 (KR) 10-2008-0089480

(51) Int. Cl. G08B 1/00

(52) U.S. Cl. 340/309.7

(57) ABSTRACT

Provided are an apparatus and method for supporting a medicine-taking service capable of supporting patients to take a medicament to dynamically comply with a dosage schedule managed in a remote control manner. The automatic distribution of the medicaments is carried out by receiving a dynamically changing dosage schedule and prescription from a server to store the received dosage schedule and prescription; checking a medicine-taking time using the dosage schedule and storing the checked medicine-taking time; informing a user and the server of the medicine-taking time; distributing a corresponding number of medicaments from corresponding vials using the dosage schedule according to a user's intention to take medicine when it is the medicine-taking time; confirming whether a user takes the distributed medicaments; and transmitting the confirmed medicine-taking results to the server.

### CROSS-REFERENCE TO RELATED APPLICATIONS

This application claims the priority of Korean Patent Application No. 2008-89480 filed on Sep. 10, 2008, in the Korean Intellectual Property Office, the disclosure of which is incorporated herein by reference.

### BACKGROUND OF THE INVENTION

1. Field of the Invention

The present invention relates to an apparatus and a method for supporting a medicine-taking service, and more particularly, to an apparatus and a method for supporting a medicine-taking service capable of supporting patients to accurately take a medicament to dynamically comply with a dosage schedule managed in a remote control manner.

2. Description of the Related Art

With recent development of medical technologies, individual health cares have been of increasing interest, and there have been increased demands for healthcare services. Although the healthcare services were mainly provided by medical institutions in the prior art, the healthcare services have recently come into wide use even by many people or in many homes. A population of people has increasingly taken medicaments so as to maintain his healthy life pattern with an increase in average life span. In the case of the medicaments to be taken, it is important to take a quantitative dose of a medicament at a given time as prescribed by a doctor and a pharmacist. Therefore, many studies are under way to accurately administer medicament in time by informing patients or their families (caregivers) of taking a medicament.

As one of conventional technologies developed for dosage management, there is widely used a medicine case informing a patient of medicine-taking time. In order to help patients take various medicaments for a long time period, the medicine case has several partitions filled in advance with a dose of medicaments, and informs the patients of a medicine-taking time during a give time period.

Also, persons who take a medicament for hyperpiesia, or patients, such as tuberculosis patients, who take several medicaments for a long time period often receive medicaments according to the prescription for more than a month. These patients should have various kinds of medicaments to be taken and take the medicaments regularly. In this case, the patients should take medicaments for a long time period, and therefore the number of medicaments to be taken may be changed according to the prescriptions as the patients' conditions becomes worse or improved.

However, conventional medicine cases have problems in that medicaments should be put into each partition of the medicine case, and, when the prescription of the patients who should take medicaments for a long time period is changed, the medicaments should be again put into each partition of the medicine case to correspond to the number of medicaments according to the changed prescription.

In order to solve the above problems, there has been an attempt to develop a medicine case whose partitions are filled respectively with medicaments according to the kinds of the medicaments, but this medicine case has a problem in that a user directly brings the medicaments out of the medicine case, and then takes the medicaments when the medicine case informs the user of a medicine-taking time. As a result, since the medicaments are not automatically distributed from the medicine case, a user should bring medicaments out of the medicine case and take the medicaments according to the user's own intention, and therefore may take the wrong medicaments when there are a variety of the medicaments in the medicine case. Accordingly, the conventional medicine cases have problems in that a user should directly record a new dosage schedule in a memory chip whenever medicine is prescribed for the patient since the medicine cases do not reflect the newly issued prescription when the patient's prescription is changed.

### SUMMARY OF THE INVENTION

The present invention is designed to solve the problems of the prior art, and therefore it is an object of the present invention to provide an apparatus and method for supporting a medicine-taking service capable of informing a user of a medicine-taking time and distributing prescribed medicaments according to a user's intention to take the medicaments so as to correspond to a dosage schedule that is dynamically changed according to a prescription issued by a doctor and a pharmacist.

According to an aspect of the present invention, there is provided an apparatus for supporting a medicine-taking service including a pill box having vials mounted therein to store medicaments to be taken according to the kinds of the medicaments; a controller receiving a dosage schedule from a server, the dosage schedule being dynamically changed according to a prescription, informing a user of a medicine-taking time according to the received dosage schedule, controlling distribution of medicaments to be taken according to the prescription, and checking whether a user takes the distributed medicaments; and a distributing port distributing the medicaments stored in each of the vials under the control of the controller when it is the medicine-taking time, the medicaments being distributed in the same number as described in the prescription.

Also, according to another aspect of the present invention, there is provided a method for supporting a medicine-taking service using the apparatus for supporting a medicine-taking service. Here, the method includes: receiving a dynamically changing dosage schedule and prescription from a server to store the received dosage schedule and prescription; checking a medicine-taking time using the dosage schedule; informing a user and the server of the medicine-taking time; distributing a corresponding number of medicaments from corresponding vials using the dosage schedule according to a user's intention to take medicine when it is the medicine-taking time; confirming whether a user takes the distributed medicaments; and transmitting the confirmed medicine-taking results to the server.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a configuration of an apparatus for supporting a medicine-taking service according to one exemplary embodiment of the present invention.

FIG. 2 is a diagram illustrating a method for supporting a medicine-taking service according to one exemplary embodiment of the present invention.

FIG. 3 is a diagram illustrating an operation of determining whether medicaments are present using a controller according to one exemplary embodiment of the present invention.

FIG. 4 is a diagram illustrating an operation of distributing medicaments to be taken using a controller according to one exemplary embodiment of the present invention.

### DETAILED DESCRIPTION OF THE PREFERRED EMBODIMENT

Exemplary embodiments of the present invention will now be described in detail with reference to the accompanying drawings. For the exemplary embodiments of the present invention, detailed descriptions of known functions and constructions that are related to the present invention are omitted for clarity when they are proven to make the gist of the present invention unnecessarily confusing.

In accordance with one exemplary embodiment of the present invention, the apparatus and method for supporting a medicine-taking service to comply with a dosage schedule being dynamically changed according to a prescription in a system for managing a user to take medicine will be described in more detail, as follows. First of all, a configuration of the apparatus for supporting a medicine-taking service is described in more detail with reference to the accompanying drawings.

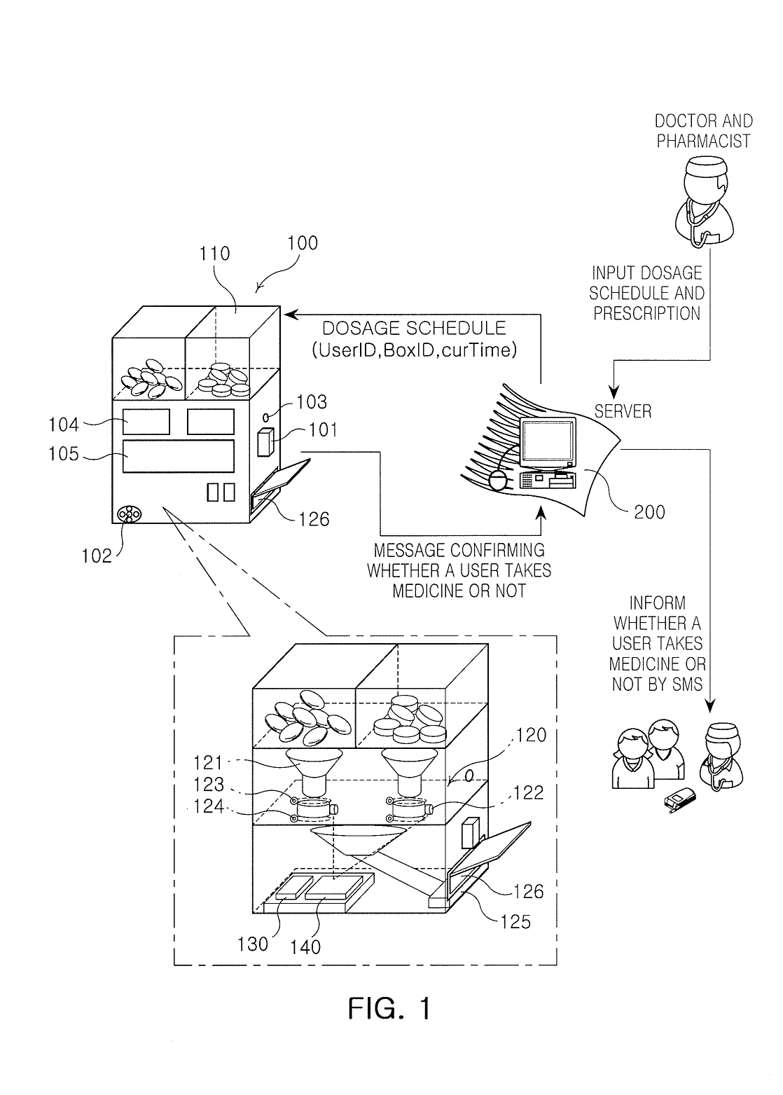

FIG. 1 is a diagram illustrating a configuration of an apparatus for supporting a medicine-taking service according to one exemplary embodiment of the present invention.

Referring to FIG. 1, the apparatus 100 for supporting a medicine-taking service may comprise a pill box 110, a distributing port 120, a controller 130 and a storage unit 140. Here, a medicine-distributing button 101, an alarm unit and a display unit may be formed outside the apparatus 100 for supporting a medicine-taking service. In this case, the medicine-distributing button 101 is pressed by a user when the user takes medicine, the alarm unit is composed of a speaker 102 informing the user of a medicine-taking time and a light emitting diode (hereinafter, referred to as ‘LED’) 103, and the display unit is composed of liquid crystal displays (hereinafter, referred to as ‘LCD’) 104 and 105 to display a content about medicine-taking information. Here, the first LCD 104 of the display unit may output a text file of corresponding vials in order to display the number of respective medicaments to be taken at this present medicine-taking time, and the second LCD 105 may output information on cautions in use of medicaments and settings of the apparatus for supporting a medicine-taking service.

Also, the apparatus 100 for supporting a medicine-taking service may construct a communication module (not shown) communicating with the server 200 to dynamically receive a dosage schedule and transmit a message for confirming whether a user takes medicine to the server 200; a timer (not shown) that may check time, a universal serial bus (USB) connection module (not shown) communicating with a computer, etc.

The pill box 110 has a plurality of vials installed therein. Here, a plurality of the vials is formed in an upper external end of the apparatus 100 for supporting a medicine-taking service so as to store a large amount of medicaments to be taken in the form of pill. The installed vials may be increased or decreased in number, and installed attachably and detachably in the apparatus 100 for supporting a medicine-taking service.

The distributing port 120 includes a plurality of medicine transfer units 121 formed in the form of funnel and attachable and detachable to each vial according to the size of medicaments; a plurality of distributers 122 coupled respectively to lower ends of the medicine transfer units 121 and using a motor controlled by the controller 130 to distribute medicaments from corresponding vials one by one; a first sensor 123 detecting whether corresponding medicaments are present in each of the medicine transfer units 121; a second sensor 124 detecting whether the medicaments are distributed by each of the distributers 122; a medicine waiting portion 125 collecting the distributed medicaments; and an outlet 126 formed outside the apparatus 100 for supporting a medicine-taking service to allow a user to bring out the collected medicaments. In this case, the distributing port 120 may be formed inside the apparatus 100 for supporting a medicine-taking service. Also, when the distributing port 120 receives a signal for distributing a medicament from the controller 130, the distributing port 120 drives the corresponding distributer 122 to distribute a dose of medicaments according to a prescription present in the medicine transfer unit 121 coupled to the corresponding distributer 122, the medicaments being distributed in the same number as described in the prescription. Here, a third sensor (not shown) detecting the presence of the collected medicaments may be further formed in the medicine waiting portion 125. This is to prevent the currently-distributed medicaments from being mixed with medicaments that will be distributed at the next medicine-taking time when the medicaments to be taken are distributed but not discharged by a user, or some of the medicaments remains by mistake in distributing the medicaments. Therefore, when the medicaments still remains in the medicine waiting portion 125 for a predetermined time after the distribution of the medicaments, the controller 130 inform a user that the medicaments to be taken are present in the medicine waiting portion 125 in order to allow the user to bring out the medicaments from the medicine waiting portion 125.

The controller 130 controls operations of many devices in the apparatus for supporting a medicine-taking service, confirms whether a dosage schedule and a prescription periodically received from the server 200 are changed into new ones, and controls distribution of medicaments to be taken. More particularly, the controller 130 checks a medicine-taking time using the dosage schedule, transmits a signal for distributing a dose of medicaments to the distributing port 120 when the controller 130 receives an intention to take medicine from a user, that is, determines whether the user presses a medicine-distributing button 101 and receives an intention to take medicine, and controls the distributing port 120 to distribute a dose of medicaments to be taken according to the prescription. Also, the controller 130 determines whether medicaments to be distributed are present in each of the medicine transfer units 121 and corresponding medicaments are distributed by each of the distributers 122, by using the detection signal transferred from the first and second sensors 123 and 124 of the distributing port 120, confirms whether a user takes medicine or not, and whether the corresponding medicaments are forcibly distributed when the user goes out, and then informs the server 200 of the confirmed results.

The storage unit 140 stores the dosage schedule and prescription received from the server 200, and stores information on a medicine-taking time and its related information included in the received dosage schedule.

The server 200 receives messages from the apparatus 100 for supporting a medicine-taking service, the messages including dose information about whether to take medicine or not and whether to forcibly distribute medicaments when a user goes out, and then informs a patient's family and caregiver that a patient takes/does not take medicine, or goes out by providing a short message service (SMS) to the patient's family and caregiver. Also, the server 200 receives a prescription from a doctor and a pharmacist to manage the received prescription, updates a dosage schedule according to the inputted prescription, and periodically transmits the updated dosage schedule to the apparatus 100 supporting a medicine-taking service. Also, the server 200 manages user's information, ID of the apparatus for supporting a medicine-taking service used by the user, and schedule information in order to support a medicine-taking service.

The user's information includes user's ID, user's name, user's contact numbers, caregiver's contact numbers, doctor's contact numbers and the like, as listed in the following Table 1, and the apparatus for supporting a medicine-taking service used by the user may be listed in the following Table 2.

TABLE 1

| | |
|---|---|
| ID | 1 |
| Name | Gil-dong, Hong |
| Tel | 010-1111-1111 |
| Caregiver's Tel | 010-1111-2222 |
| Doctor's Tel | 010-1111-3333 |

TABLE 2

| | ID of Apparatus for |
|---|---|
| | supporting a |
| ID | medicine-taking service |
| 1 | 100-1 |

The schedule information includes ID of the apparatus for supporting a medicine-taking service, dates, start time, names for medicine, vial numbers, doses, cautions, whether to take medicine or not, etc., as listed in the following Tables 2 and 3. In addition to the information, the schedule information may include other information required for supporting a medicine-taking service.

The server 200 finds errors such as the overlapping of some period in a program in which a dosage schedule is inputted and revised using a graphical user interface (GUI), and stores the inputted schedule by individual unit in consideration of the medicine-taking time gaps. For example, it is assumed that a user takes 3 pills of medication B and 2 pills of medication C in the morning and evening every day during one month of January. Here, when the user inputs a start date (Jan. 1, 2008), an end date (Jan. 1, 2008), and a medicine-taking time gap by day, and inputs a medicine-taking time and the number of medicine, a new dosage schedule is generated in the server 200, as listed in the following Table 3. If a new prescription is issued to reduce the medication B to one pill when a patient's clinical condition has improved after the patient takes medicine during a 15-day time period, the schedule after 15 days of taking medicine needs to be revised as listed in the following Table 4.

TABLE 3

| | | Start | Medication | | No. of | | |
|---|---|---|---|---|---|---|---|
| ID | Date | time | name | Vial No. | Medication | Cautions | Dosage |
| 100-1 | 2008-01-01 | 08:00 | B | 1 | 2 | 30 min | 0 |
| | | | | | | after | |
| | | | | | | meal | |
| 100-1 | 2008-01-01 | 08:00 | C | 2 | 2 | 30 min | 0 |
| | | | | | | after | |
| | | | | | | meal | |
| 100-1 | 2008-01-01 | 18:00 | B | 1 | 2 | 30 min | 0 |
| | | | | | | after | |
| | | | | | | meal | |
| 100-1 | 2008-01-01 | 18:00 | C | 2 | 2 | 30 min | 0 |
| | | | | | | after | |
| | | | | | | meal | |
| 100-1 | 2008-01-31 | 18:00 | C | 2 | 2 | 30 min | 0 |
| | | | | | | after | |
| | | | | | | meal | |

TABLE 4

| | | Start | Medication | | No. of | | |
|---|---|---|---|---|---|---|---|
| ID | Date | time | name | Vial No. | Medication | Cautions | Dosage |
| 100-1 | 2008-01-01 | 08:00 | B | 1 | 2 | 30 min | 1 |
| | | | | | | after | (Taken) |
| | | | | | | meal | |
| 100-1 | 2008-01-01 | 08:00 | C | 2 | 2 | 30 min | 1 |
| | | | | | | after | |
| | | | | | | meal | |
| 100-1 | 2008-01-01 | 18:00 | B | 1 | 2 | 30 min | 1 |
| | | | | | | after | |
| | | | | | | meal | |
| 100-1 | 2008-01-01 | 18:00 | C | 2 | 2 | 30 min | 2 (Out) |
| | | | | | | after | |
| | | | | | | meal | |
| 100-1 | 2008-01-15 | 08:00 | B | 1 | 1 | 30 min | 0 (Not |
| | | | | | | before | taken) |
| | | | | | | meal | |
| 100-1 | 2008-01-31 | 18:00 | B | 1 | 1 | 30 min | 0 |
| | | | | | | before | |
| | | | | | | meal | |

Hereinafter, the method for supporting a medicine-taking service according to one exemplary embodiment of the present invention in the above-mentioned apparatus for supporting a medicine-taking service is described in more detail with reference to the accompanying drawings.

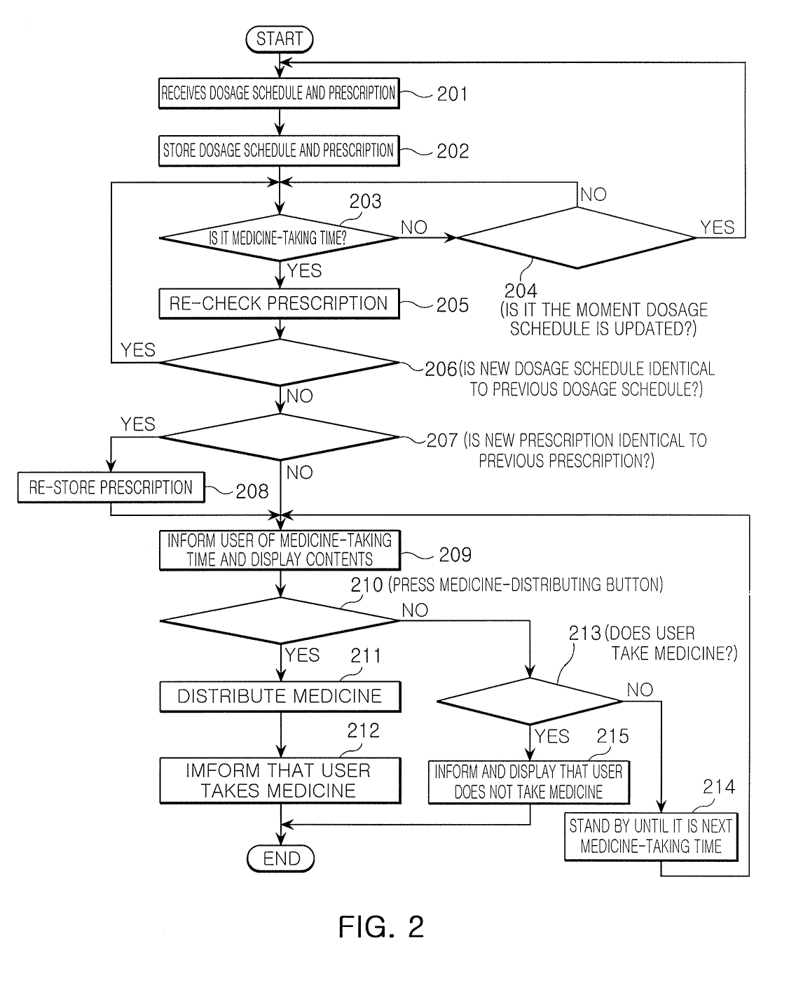

FIG. 2 is a diagram illustrating a method for supporting a medicine-taking service according to one exemplary embodiment of the present invention.

Referring to FIG. 2, whenever the apparatus 100 for supporting a medicine-taking service is turned on, the apparatus for supporting a medicine-taking service 100 receives a dosage schedule from a server 200 and stores the received dosage schedule, transfers a user's ID, ID of the apparatus for supporting a medicine-taking service and time to the server 200, receives a prescription of medicaments from the server, the medicaments being taken first of all among the medicaments that the user does not take after this present time, and stores the received prescription. Then, the apparatus 100 for supporting a medicine-taking service receives a dosage schedule from the server 200 at given time gaps (Operation 201). In this case, the received dosage schedule may be a dosage schedule that is updated according to the prescription inputted into the server 200 by a doctor or a pharmacist.

Next, the apparatus 100 for supporting a medicine-taking service determines a medicine-taking time from the difference in time of a timer and a pre-set time of the received dosage schedule, and records the determined medicine-taking time and a prescription corresponding to the medicine-taking time (Operation 202).

Then, the apparatus 100 for supporting a medicine-taking service checks whether it is the moment a user takes medicine. In this case, operation 205 is performed when it is the medicine-taking time, but the apparatus 100 for supporting a medicine-taking service checks whether the dosage schedule is updated when it is not the medicine-taking time (Operation 204). As a result, operation 201 is performed when the schedule is updated, but operation 203 is performed when the schedule is not updated.

Subsequently, the apparatus 100 for supporting a medicine-taking service accesses the server 200 at the medicine-taking time once more, and then re-receives the prescription and the dosage schedule stored in the server 200 so as to prepare for an event that the prescription is changed in a remote control manner (Operation 205). Then the apparatus 100 for supporting a medicine-taking service checks whether a newly received dosage schedule is identical to the previously received dosage schedule by comparing the newly received dosage schedule with the previously received dosage schedule (Operation 206). As a result, the apparatus 100 for supporting a medicine-taking service updates the previously received dosage schedule by exchanging the previously received dosage schedule with the newly changed dosage schedule when the newly received dosage schedule is not identical to the previously received dosage schedule, and stores the updated dosage schedule, followed by performing operation 203. However, when the newly received dosage schedule is identical to the previously received dosage schedule, the apparatus 100 for supporting a medicine-taking service confirms whether the newly received prescription is identical to the previous prescription (Operation 207).

As a result, when the newly received prescription is not identical to the previous prescription, the apparatus 100 for supporting a medicine-taking service updates the previously received prescription by exchanging the previously received prescription with the newly changed prescription, followed by performing operation 209. For example, when a dosage schedule of medicaments to be taken the next time is stored as (Jan. 15, 2008-18:00, 1, 3) and (Jan. 15, 2008-18:00, 2, 2) in the storage unit 140 after a user has taken medicine in the morning of 15, January, the apparatus 100 for supporting a medicine-taking service checks once more whether the dosage schedule and prescription stored in the storage unit 140 are identical to the dosage schedule and prescription stored recently in the server 200 on the medicine-taking time (18 o'clock). For example, when a context of the prescription is revised into ‘(Jan. 15, 2008-1800, 1, 3)’, which means a user does not need to take medicine 2, by a doctor and a pharmacist several seconds before 18 o'clock, the apparatus 100 for supporting a medicine-taking service re-stores the revised prescription in the storage unit 140.

Where the two prescriptions are identical to each other, the apparatus 100 for supporting a medicine-taking service informs a user that it is the medicine-taking time (Operation 209). For this purpose, the controller 130 of the apparatus 100 for supporting a medicine-taking service generates a message informing that it is the medicine-taking time, and transfers the generated message to the server 200. In this case, the controller 130 turns on an LED 103 of the display unit to visually inform a user that it is the medicine-taking time, and simultaneously uses a speaker 102 to auditorily inform the user that it is the medicine-taking time, and then displays the number of medicaments in corresponding vials and cautions on the LCD 104 and 105 according to the prescription. Informing a user of the medicine-taking time is repeatedly performed at constant time gaps, and then finished when the controller 130 determines that a user does not take medicine in the subsequent operations. In this case, the controller 130 turns off the LED 103, removes an output of the speaker 102 to inform a user of the medicine-taking time, turns off LCD 104 in each vial, and transfers to the server 200 a message informing that a user does not take medicine.

Subsequently, the apparatus 100 for supporting a medicine-taking service checks whether a user presses a medicine-distributing button 101 so as to deliver his intention to take medicine (Operation 210). Then, operation 211 is performed when the user presses the medicine-distributing button 101 so as to deliver his intention to take medicine, and operation 213 is performed when the user does not press the medicine-distributing button 101.

When the user presses the medicine-distributing button 101, the apparatus 100 for supporting a medicine-taking service confirms the dosage schedule and distributes medicaments from corresponding vials of the pill box 110 through the distributing port 120 (Operation 211). That is to say, the controller 130 of the apparatus 100 for supporting a medicine-taking service uses the prescription to check whether it is the medicine-taking time when the controller 130 receives an input signal generated when the user presses the medicine-distributing button. As a result, when it is the medicine-taking time, the controller 130 confirms whether medicaments are present in corresponding vials of the pill box 110. Then, the controller 130 operates the distributing port 120 to repeatedly distribute a corresponding number of the medicaments one by one according to the corresponding dosage schedule when the medicaments are present in the corresponding vials of the pill box 110. In this case, the controller 130 confirms whether the medicaments are distributed by receiving a detection signal from the sensors 123 and 124 installed in the distributing port 120. On the contrary, where the controller 130 receives an input signal of the medicine-distributing button 101 when it is not a medicine-taking time, the controller 130 outputs a warning message informing that it is not the medicine-taking time. Then, where the controller 130 receives input signals generated when the user repeatedly presses the medicine-distributing button 103, the controller 130 checks whether a user forcibly distributes the medicaments in order for the user to go out, and then distributes a combination of medicaments when the controller 130 confirms that the user forcibly distributes the medicaments in order for the user to go out.

Then, the apparatus 100 for supporting a medicine-taking service determines that the user took medicine when the medicaments are distributed, and transmits a message for informing the server 200 that the user took medicine (Operation 212). As a result, this operation is completed. In this case, the controller 130 of the apparatus 100 for supporting a medicine-taking service turns off the LED 103 of the display unit, resets the LCD 104 displaying the number of medicaments, and then returns to a stand-by mode so as to receive a dosage schedule for medicaments to be taken the next time. When a user forces the controller 130 to distribute medicaments in order for the user to go out, the apparatus 100 for supporting a medicine-taking service informs the server 200 of whether the medicaments are forcibly distributed in order for the user to go out. Therefore, the server 200 transmits a short message service (SMS) to a user's cell phone to inform the user that it is the medicine-taking time even when the user goes out.

On the contrary, when there is no demand for distribution of medicaments as the results of operation 210, the apparatus 100 for supporting a medicine-taking service checks whether a user does not take the medicaments (Operation 213). As a result, when it is not in the state where the user does not take the medicaments, the apparatus 100 for supporting a medicine-taking service stands by until it is the next medicine-taking time (Operation 214), followed by performing operation 209. On the contrary, when it is in the state where the user does not take the medicaments, the apparatus 100 for supporting a medicine-taking service displays on the LCD 105 that the user does not take medicine, and then transmits a message for informing that a user does not medicine to the server 200 (Operation 215).

Then, the server 200 receives a message for infirming whether a user takes medicine or not, records dose information in a corresponding schedule, and transmits the dose information in the form of SMS to a user's family and caregivers.

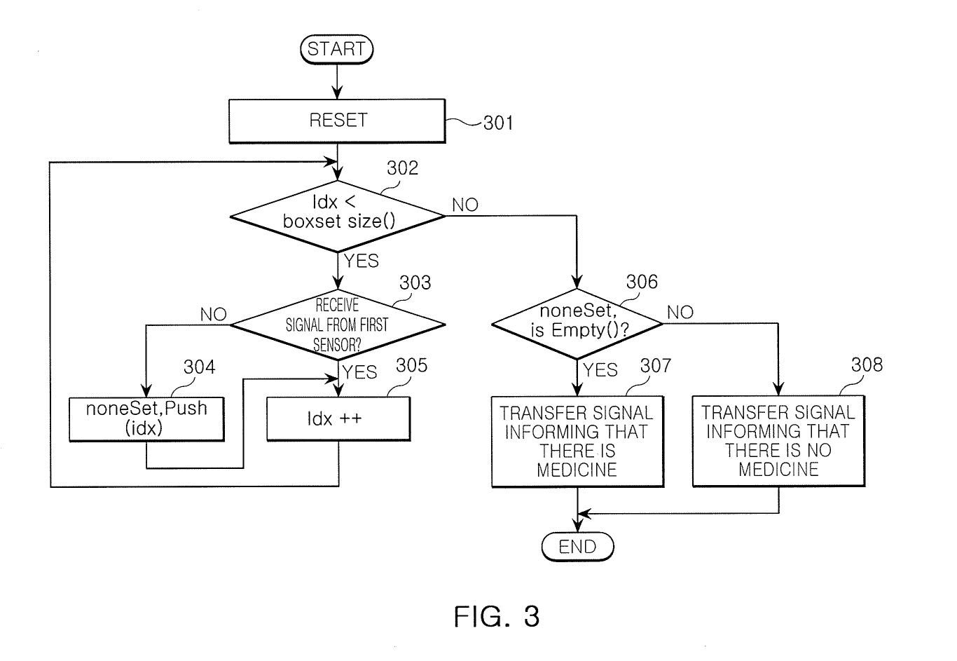

Among the above-mentioned operations, the operation of checking whether medicaments as listed in the prescription are present in the pill box 110 is described in more detail with reference to FIG. 3.

In order to check whether medicaments are present in the pill box 110, information on a set of vial numbers of medicaments to be taken (boxSet), indexes (Idx) of the boxSet, a set of medicament-free vial numbers (noneSet) and the like is required.

Referring to FIG. 3, the controller 130 of the apparatus 100 for supporting a medicine-taking service resets information to determine whether the medicaments are present in the pill box 110 (Operation 301).

Next, since the kinds of the medicaments to be taken may be changed according to the dosage schedule, the controller 130 of the apparatus 100 for supporting a medicine-taking service does not determine whether medicaments are present in all vials of the pill box 110, but determines whether medicaments are present in the pill box 110 by sequentially detecting the medicaments, using the sensor 123, according to ID of the vials including the medicaments to be taken according to the dosage schedule. That is to say, the controller 130 confirms whether the Idx is smaller than a size of the set of vial numbers (boxSet size ( )) containing the medicaments to be taken (Operation 302). As a result, the controller 130 performs operation 306 when the Idx is higher than the size of the boxSet size ( ), and determines whether it receives a detection signal from the first sensor 123 of the distributing port 120 (Operation 303) when the Idx is not higher than the size of the boxSet size( ). That is to say, since a user does not see the medicaments from the outside of the apparatus 100 for supporting a medicine-taking service when the medicaments are transferred to the distributing port 120, the controller 130 detects whether the medicaments are present in the medicine transfer unit 121 by using the first sensor 123.

As the results of operation 303, when the controller 130 does not receive the detection signal from the first sensor 123, the controller 130 inputs ID of corresponding vials into noneSet (noneSet.push (idx)) (Operation 304), followed by performing operation 305. Meanwhile, the controller 130 increases the Idx (Idx ++) (Operation 305) when the controller 130 receives the detection signal.

As the results of operation 302, the controller 130 determines whether the set of medicament-free vial numbers (noneSet) is empty (noneSet.isEmpty ( )) (Operation 306) when the Idx is higher than, or identical to the size of the set of vial numbers (boxSet size ( )) containing the medicaments to be taken as described in operation 302, that is, when inspection on all vials containing the medicament to be taken is completed. As a result, the controller 130 determines that medicaments remain in the pill box 110 when the set of medicament-free vial numbers (noneSet) is empty, and determines that medicaments are not present in the pill box 110 when the set of medicament-free vial numbers (noneSet) is not empty, thus to display a corresponding signal. When the medicaments are not present in the pill box 110, the controller 130 also displays a corresponding signal together with ID of the vials.

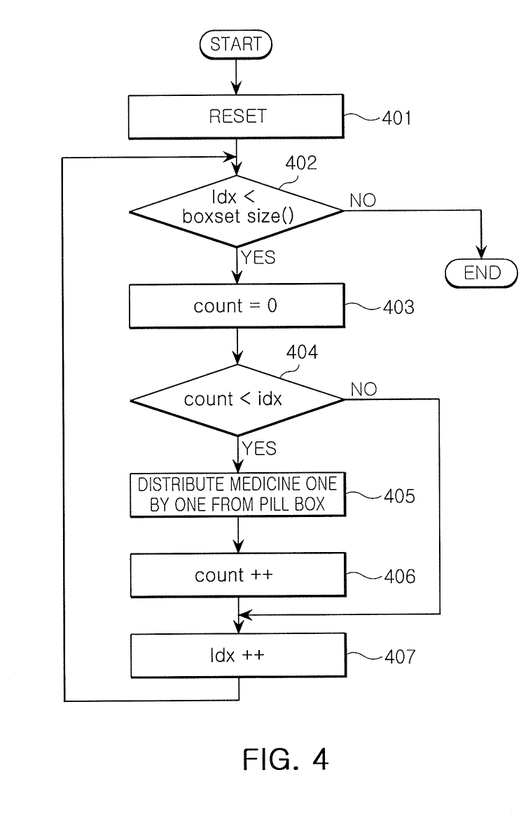

As described above, the controller 130 determines the presence of the medicaments, and then distributes a combination of the medicaments. Here, the operation of distributing medicaments is described in more detail with reference to FIG. 4.

Referring to FIG. 4, the controller 130 of the apparatus 100 for supporting a medicine-taking service resets a set of vial numbers of medicaments to be taken (boxSet), indexes (Idx) of the boxSet (Operation 401), and determines whether the Idx is smaller in a size of the set of vial numbers of medicaments to be taken (boxSet size( )) (Operation 402). As result, the controller 130 performs operation 403 when the Idx is smaller than the size of the set of vial numbers of medicaments to be taken (boxSet size( )), and finishes this operation when the Idx is not smaller than the size of the set of vial numbers of medicaments to be taken (boxSet size( )).

Then the controller 130 sets a count to ‘0’ (Operation 403), and determines whether the count is smaller than the number (Idx #) of medicaments to be taken in the vials (Operation 404), and increases the Idx (Idx++) (Operation 407) when the count is not smaller than the number (Idx #) of medicaments in the vials, followed by returning to operation 402. On the contrary, when the count is smaller than the number (Idx #) of medicaments in the vials, controller 130 distributes one medicament corresponding to the Idx # from the corresponding vial, and increases the count (count++) (Operation 405), followed by returning to operation 404.

Therefore, the apparatus for supporting a medicine-taking service according to one exemplary embodiment of the present invention may update a dosage schedule, automatically inform a user of a medicine-taking time according to the updated dosage schedule and distribute corresponding medicaments according to the prescription without re-receiving medicaments that a user takes or re-inputting the dosage schedule even when the dosage schedule stored in the server is dynamically changed. Therefore, the apparatus for supporting a medicine-taking service according to one exemplary embodiment of the present invention may be useful to support a user to take medicine more accurately and regularly, thus to improve user's health.

While the present invention has been shown and described in connection with the exemplary embodiments, it will be apparent to those skilled in the art that modifications and variations can be made without departing from the spirit and scope of the invention as defined by the appended claims. Therefore, it should be understood that the scope of the present invention is not designed to limit the exemplary embodiments of the present invention, but is construed as being the appended claims and equivalents thereof.

What is claimed is:

1. An apparatus for supporting a medicine-taking service, comprising:
a pill box having vials mounted therein to store medicaments to be taken according to the kinds of the medicaments;
a controller receiving a dosage schedule from a server, the dosage schedule being dynamically changed according to a prescription, informing a user of a medicine-taking time according to the received dosage schedule, controlling distribution of medicaments to be taken according to the prescription, and checking whether a user takes the distributed medicaments; and
a distributing port distributing the medicaments stored in each of the vials under the control of the controller when it is the medicine-taking time, the medicaments being distributed in the same number as described in the prescription.

2. The apparatus for supporting a medicine-taking service of claim 1, further comprising a storage unit storing the dosage schedule and dose information required for supporting the medicine-taking service.

3. The apparatus for supporting a medicine-taking service of claim 1, further comprising:
an alarm unit informing a user of the medicine-taking time visually and auditorily;
a display unit displaying the number of each medicament to be taken and outputting messages regarding cautions in use and settings of the apparatus for supporting a medicine-taking service; and
a medicine-distributing button pressed when a user takes medicine.

4. The apparatus for supporting a medicine-taking service of claim 1, wherein the distributing port comprises:
a plurality of medicine transfer units attachable/detachable to/from each of the vials according to the sizes of the medicaments to transfer the medicaments in each of the vials;
a plurality of distributers coupled respectively to lower ends of the medicine transfer units to repeatedly distribute a corresponding number of the transferred medicaments one by one according to a user's intention to take the medicaments, the corresponding number of the transferred medicaments being listed in a dosage schedule;
a plurality of first sensors sensing whether corresponding medicaments are present in each of the medicine transfer units;
a plurality of second sensors sensing whether the medicaments are distributed from each of the distributers;
a medicine waiting portion collecting the medicaments distributed from each of the distributers; and
an outlet outputting the medicaments collected in the medicine waiting portion.

5. The apparatus for supporting a medicine-taking service of claim 1, wherein the controller transfers information on a user's ID, ID of the apparatus for supporting a medicine-taking service and time to the server and receives a prescription of medicaments from the server, the medicaments being taken first of all among the medicaments that the user does not take after this present time.

6. The apparatus for supporting a medicine-taking service of claim 5, wherein, when it is the medicine-taking time, the controller receives a dosage schedule and a prescription from the server, compares the dosage schedule and the prescription with the previously received dosage schedule and prescription to confirm whether the newly received dosage schedule and prescription are identical to the previously received dosage schedule and prescription, re-stores the newly received dosage schedule and prescription when the newly received dosage schedule and prescription are different from the previously received dosage schedule and prescription, and informs the user of a new medicine-taking time.

7. The apparatus for supporting a medicine-taking service of claim 1, wherein the dosage schedule is received from the server at given time gaps from a time point when the apparatus for supporting a medicine-taking service is turned on.

8. A method for supporting a medicine-taking service using the apparatus for supporting a medicine-taking service, the method comprising:
receiving a dynamically changing dosage schedule and prescription from a server to store the received dosage schedule and prescription;
checking a medicine-taking time using the dosage schedule;
informing a user and the server of the medicine-taking time;
distributing a corresponding number of medicaments from corresponding vials using the dosage schedule according to a user's intention to take medicine when it is the medicine-taking time;
confirming whether a user takes the distributed medicaments; and
transmitting the confirmed medicine-taking results to the server.

9. The method of claim 8, further comprising:
confirming whether the prescription and dosage schedule stored currently in the server are changed when it is the medicine-taking time;
updating the previously received prescription and dosage schedule by exchanging the previously received prescription and dosage schedule with the newly changed prescription and dosage schedule when the prescription and dosage schedule stored currently in the server are changed; and
re-checking a medicine-taking time using the updated dosage schedule.

10. The method of claim 9, further comprising:
sending a warning message when the apparatus for supporting a medicine-taking service receives a message of an intention to take medicine from a user when it is not the medicine-taking time;
forcibly distributing corresponding medicaments when a user goes out; and
informing the server of the forcible distribution of the corresponding medicaments.

11. The method of claim 8, wherein the operation of receiving a dynamically changing dosage schedule and prescription from a server to store the received dosage schedule and prescription comprises:
receiving a dosage schedule from a server to store the received dosage schedule;
transferring information on a user's ID, ID of the apparatus for supporting a medicine-taking service and a dosage time to the server;
receiving a prescription of medicaments from the server to store the prescription of medicaments, the medicaments being taken first of all among the medicaments that the user does not take after this present time; and
receiving a dosage schedule and a prescription from the server at given time gaps to update the previously stored dosage schedule and prescription.

12. The method of claim 8, wherein the operation of distributing a corresponding number of medicaments from corresponding vials using the dosage schedule according to a user's intention to take medicine when it is the medicine-taking time comprises:
checking a user's intention to take medicine when it is the medicine-taking time;
checking a dosage schedule of the medicine-taking time when the user's intention to take medicine is received from the user;
detecting the presence of medicaments transferred from the corresponding vials according to the checked dosage schedule;
distributing a corresponding number of the transferred medicaments one by one according to the checked dosage schedule; and
detecting the distribution of the transferred medicaments.
